(19) United States
(12) Patent Application Publication
(10) Pub. No.: US 2022/0322825 A1
(43) Pub. Date: Oct. 13, 2022

(54) MODULAR OUTDOOR KITCHEN CAPABLE OF TOOL-LESS ASSEMBLY

(71) Applicant: RTA Outdoor Living, LLC, Greenland, NH (US)

(72) Inventors: Joshua Brown, Greenland, NH (US); Joshua Freeman, West Boxford, MA (US); Bradley Jones, Richmond, IN (US)

(73) Assignee: RTA Outdoor Living, LLC, Greenland, NH (US)

(21) Appl. No.: 17/658,512

(22) Filed: Apr. 8, 2022

Related U.S. Application Data
(60) Provisional application No. 63/173,048, filed on Apr. 9, 2021.

(51) Int. Cl. A47B 77/02; A47B 47/00

(52) U.S. Cl. CPC A47B 77/02; A47B 47/0075

(57) ABSTRACT

A modular outdoor kitchen assembly that includes panels that can be assembled without the use of tools or fasteners. The kitchen assembly may include a front panel and back panel that are attached by side panels that span between the front panel and the back panel. A countertop may be coupled to the top edges of the panels. Cutouts may be formed through the countertop and the one or more of the modular panels to create space for the installation of a grill or other appliances within the outdoor kitchen assembly. Vent openings may be defined through the modular panels to allow expulsion of gases and cooling within the interior space of the kitchen assembly.

### CROSS REFERENCE TO RELATED APPLICATIONS

This application claims the benefit of U.S. Provisional Patent Application Ser. No. 63/173,048 filed on Apr. 9, 2021, which is hereby incorporated by reference.

### BACKGROUND

Outdoor kitchens have become an increasingly prevalent feature in backyards and patios as home owners extend the functionality of the home into an outdoor living area. Outdoor kitchens typically are defined by a surround (vertical walls) topped with a countertop housing a built-in outdoor grill supplemented with optional appliances such as sinks, outdoor refrigerators and/or storage solutions.

Currently, the most common construction methods for building outdoor kitchen surrounds are: 1) to build an internal structural frame (often built with aluminum or steel), cover this frame with a cementous panel (such as cement board), and then apply an aesthetic texture (such as stucco) or adhere a stone veneer to the cementous panel; 2) to build an internal structure with cement block and then apply an aesthetic texture (such as stucco) or adhere a stone veneer to the cement block structure; or 3) to build the entire structure with stacked blocks or bricks, with or without mortar.

Each of these methods is time consuming and labor intensive. These methods are also limited by their dependence upon expensive specialty construction and masonry skill sets. Method #2 and #3 are limited by the weight of the block, which must be installed on a solid foundation such as a poured concrete slab. Method #1 and #2 are subject to failure as the aesthetic texture or stone veneer can detach from the sub-structure, particularly in environments that experience freeze-thaw cycles.

Thus, there is a need for improvement in this field.

### SUMMARY

In an exemplary embodiment, a modular outdoor kitchen assembly includes a front panel and a back panel and side panels extending between the front and back panels. In some instances, an internal panel may be included to provide additional support. A countertop is attached to the top edges of the panels. Cutouts may be made through the panels, particularly the front panel, and the countertop to allow installation of desired appliances, such as a grill, in the outdoor kitchen assembly.

The panels are secured to each other using a method that does not require the use of bolts, screws, or other fasteners to be assembled and does not require the use of additional tools. In one embodiment, the modular panels may be attached to each other using a tongue and groove system. For example, grooves may be included on the front and back panels and corresponding tongues may be included on the side panels to slidably mate with the grooves to secure the side panels to the front and the back panels. The grooves and connections are designed to ensure the assembly remains square.

The size, shape, and the connection points of the modular panels may be modified as desired to create a customized, outdoor kitchen assembly. Fewer panels or more panels may be used in different embodiments and the shape of the panels may be modified to fit any desired space.

In some examples, the modular outdoor kitchen assembly may include a front panel, a back panel, a right side panel that spans between the front panel and the back panel, and a left side panel that spans between the front panel and the back panel. The panels may be connected together to form an interior space. A countertop may be positioned on top of the connected panels and covering the interior space.

One or more gaps may be defined through a portion of an underside of the countertop. When the countertop is positioned on top of the panels, these gaps may be aligned with tenons that extend from the top edges of the panels that form the outdoor kitchen assembly. The tenons are designed to fit within the corresponding gaps, and lateral movement of the gaps with respect to the tenons assists to secure the countertop with respect to the panels.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a front perspective view of a modular outdoor kitchen assembly according to one aspect of the present invention.

FIG. 2 is a front elevation view of the kitchen assembly of FIG. 1.

FIG. 3 is a rear elevation view of the kitchen assembly of FIG. 1.

FIG. 4 is a right side elevation view of the kitchen assembly of FIG. 1.

FIG. 5 is a left side elevation view of the kitchen assembly of FIG. 1.

FIG. 6 is a plan view of an exemplary tongue and groove connection for the kitchen assembly of FIG. 1.

FIG. 7 is a rear elevation view of a front panel of the kitchen assembly of FIG. 1.

FIG. 8 is a front elevation view of a rear panel of the kitchen assembly of FIG. 1.

FIG. 9 is a front elevation view of a side panel of the kitchen assembly of FIG. 1.

FIG. 10A is a front elevation view of an internal panel of the kitchen assembly of FIG. 1.

FIG. 10B is a top elevation view of an internal panel of the kitchen assembly of FIG. 1.

FIG. 11 is a perspective view of an embodiment of an L-shaped modular kitchen assembly.

FIG. 12 is a representative view of a tongue and groove system that includes a bottom stop for the kitchen assembly of FIG. 1.

FIG. 13 is a diagram illustrating a tenon and gap system for attaching to countertop of the kitchen assembly of FIG. 1.

FIG. 14 is a front view of an adjustable leg assembly for the kitchen assembly of FIG. 1.

FIG. 15 is a representative view of a support brace for an appliance to be installed in the kitchen assembly of FIG. 1.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

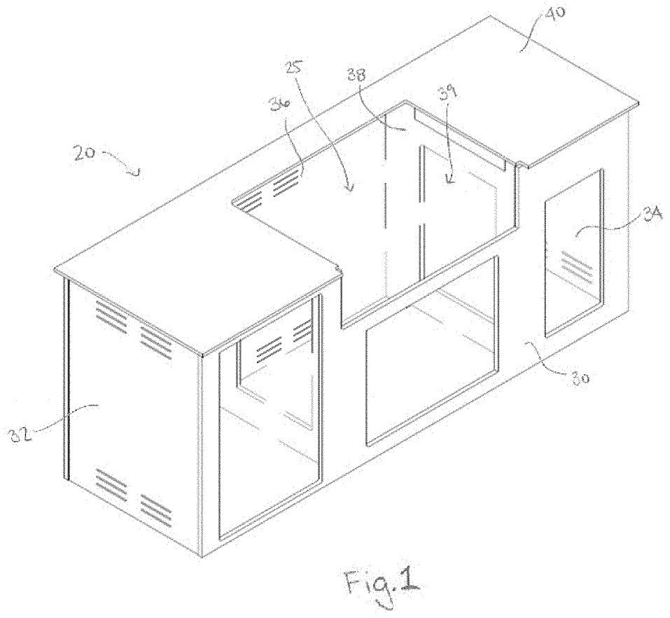

FIG. 1 illustrates a front perspective view of a ready-to-assemble outdoor kitchen assembly 20 that is made from modular panels according to one embodiment of the present invention. In the embodiment shown, the outdoor kitchen assembly 20 includes a front panel 30, two side panels 32, 34, a back panel 36, and is topped with a countertop 40. In some embodiments, the countertop 40 may be joined to the modular panels 30, 32, 34, 36, 38 using an adhesive combined with locating dowels or thru-pegs to secure the countertop 40 to the top of the modular panels. The countertop 40 may be pre-formed, such as by CNC milling, with all of the cutouts for appliances that are to be included in the outdoor kitchen assembly 20.

The modular panels 30, 32, 34, 36 define an interior space 25 within the outdoor kitchen assembly 20 that may hold appliances, such as a grill or a refrigerator, and provide a storage area. In the embodiment shown in FIG. 1, an internal panel 38 is located within the interior space 25 and extends between the front panel 30 and the back panel 36. The internal panel 38 may provide additional support and rigidity for the outdoor kitchen assembly 20. In some embodiments, an internal panel opening 39 may be defined through the internal panel 38 to allow air flow within the interior space 25 of the outdoor kitchen assembly 20. The modular panels 30, 32, 34, 36, 38 and the countertop 40 may be shipped and stored in a flat container and assembled on-site. In some embodiments, the outdoor kitchen assembly 20 may be assembled without any tools or fasteners.

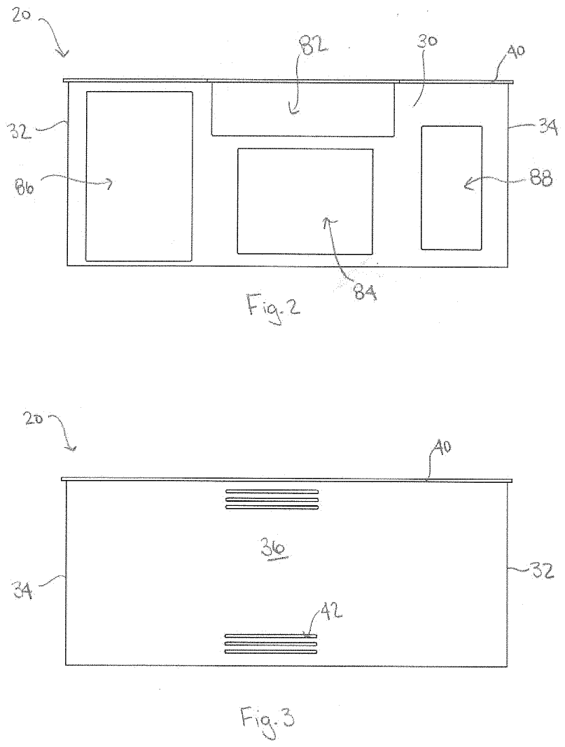

As shown in the front view of the outdoor kitchen assembly 20 illustrated in FIG. 2, appliance cutouts may be defined though the modular panels, particularly the front panel 30, and the countertop 40 to allow appliances and other structures to be installed within outdoor kitchen assembly 20. In the embodiment shown in FIG. 1, a grill cutout 82 is defined through a top edge of the front panel 30 and through the countertop 40 to allow a grill to be inserted into the outdoor kitchen assembly 20 and to allow the top of the grill to be accessible to a user. The front panel 30 may also include a lower grill cutout 84 below the grill cutout 82 to provide access to the lower portion of the grill that is fit into the outdoor kitchen assembly 20 or to a storage compartment which may be accessed by a door assembly which is mounted to the lower grill cutout 84 or other desired accessory.

The front panel 30 may also include additional cutouts allowing access to other appliances or to storage areas. Storage cutouts 86, 88, for example, may be defined through the front panel 30 on either side of the grill cutout 82 and the lower grill cutout 84. The storage cutouts 86, 88 may be used for various purposes, such as providing access to a refrigerator included in outdoor kitchen assembly 20 or for providing a storage space and providing access to a propane tank that is used to operate the grill or to a valve or other components where the grill is directly plumbed to a gas line. In other embodiments, one or both of the storage cutouts 86, 88 may include shelves for storage of items that may be used with the grill or other cooking appliances.

In some embodiments, the modular panels may initially ship with no cutouts, allowing an installer to be able to create their own cutouts in the modular panels specific to the needs of the appliances being installed in the outdoor kitchen assembly 20. In other embodiments, the cutouts may be selected and defined by the manufacturer or customer and formed in the modular panels prior to being shipped, to speed up installation time and increase installation efficiency.

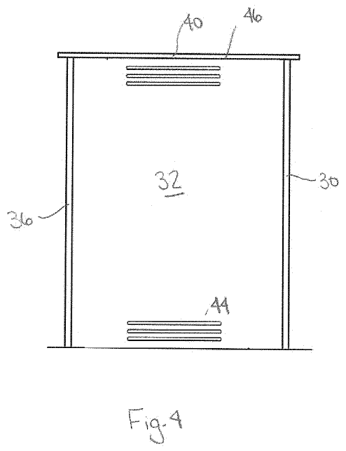

A rear view of the outdoor kitchen assembly 20 is illustrated in FIG. 3. As shown, the back panel 36 attaches to the right side panel 32 and the left side panel 34 as will be described further herein. Additionally, the back panel 36 includes vent openings 42, such as near a bottom edge of the back panel 36. These vent openings 42 are defined through the back panel 36 and allow gasses within the interior space 25 of the outdoor kitchen assembly to escape from the interior space 25 to the environment exterior of the outdoor kitchen assembly 20.

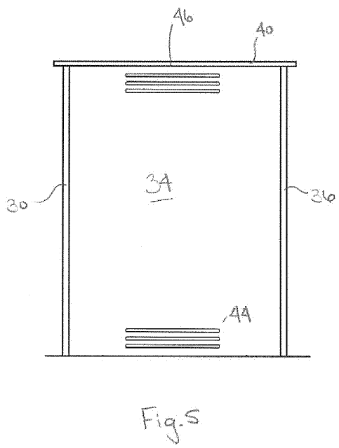

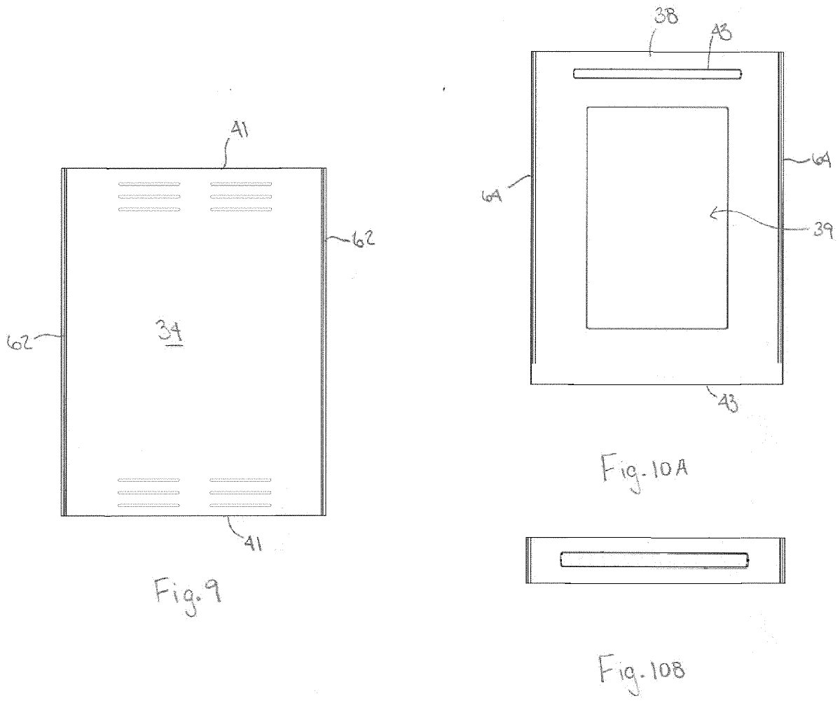

A right side view of the outdoor kitchen assembly 20 is shown in FIG. 4. As shown, the right side panel 32 extends between the front panel 30 and the back panel 36, and the countertop 40 is attached on the top edge of each of the front panel 30, the right side panel 32, and the back panel 36. As shown in FIG. 9, each of the side panels 32, 34 may include a cutout portion 41 on the top edge and/or the bottom edge of the panel 32, 34. The cutout portion 41 on the bottom edge defines a bottom side vent opening 44 between the right side panel 32 and the floor or the support surface on which the outdoor kitchen assembly 20 rests. The bottom side vent opening 44 allows gas and/or fluid to escape from the interior space 25 of the outdoor kitchen assembly 20. The cutout portion 41 on the top edge of the right side panel defines a top side vent opening 46 between the right side panel 32 and the countertop 40. The top side vent opening 46 allows gas to escape from the interior space 25 of the outdoor kitchen assembly 20.

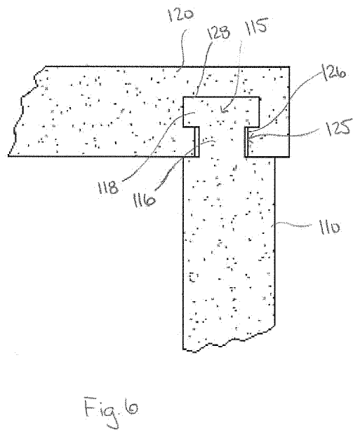

A left side view of the outdoor kitchen assembly 20 is illustrated in FIG. 5. The left side panel 34 is symmetrical with respect to the right side panel 32 and extends between the front panel 30 and the back panel 36. Similar to right side panel 32, the left side panel 34 may include a corresponding bottom side vent opening 44 that is defined between a bottom edge of the left side panel 34 and the floor or the support surface on which the outdoor kitchen assembly 20 rests. A top side vent opening 46 may also be defined between a top edge of the left side panel 34 and the counter top 40.

As illustrated in FIGS. 3-5, the side panels 32, 34 and the back panel 36 may each define vent openings 42, 44, 46 that extend through the panels 32, 34, 36. In some instances, these vent openings 42, 44, 46 may be necessary to allow cross-ventilation of a gas grill enclosed in the outdoor kitchen assembly 20. The cross-ventilation allows any explosive gases to be expelled from the outdoor kitchen assembly in the event that there is a leak. In some embodiments, further vent openings may be defined through the front panel 30.

Gases that are lighter than air, such as natural gas, may be vented from the vent openings 46 that are located near the top edges of the side panels 32, 34 of the outdoor kitchen assembly 20. Gasses that are heavier than air, such as liquid propane, may be vented from the vent openings 42, 44 near the bottom edges of the modular panels 32, 34, 36. The addition of vent openings 42, 44, 46 also facilitates a more rapid removal of heat from the outdoor kitchen assembly 20, allowing cool air to be drawn in the through the bottom vent openings 42, 44 and hot air to be expelled from the top vent openings 46.

In some embodiments, each of the panels 30, 32, 34, 36, 38 is made from a high-density polyethylene (HDPE). In other embodiments, one or more of the panels 30, 32, 34, 36, 38 may be made from another suitable rigid material. Each of the panels may be made from the same material, but in some embodiments, some of the panels may be made from a different material. For example, the front panel 30 and the back panels 36 may be made from a phenol plastic while the side panels 32, 34 and the internal panel 38 may be made from HDPE. In some instances, the panels 30, 32, 34, 36, 38 may also include an exterior panel that overlays the modular panel 30, 32, 34, 36, 38 to provide an attractive finished outer surface. In some embodiments, all of the modular panels 30, 32, 34, 36, 38 include an exterior panel, but in other embodiments, only a combination of the modular panels but not all of the modular panels includes an exterior panel.

The modular panels 30, 32, 34, 36, 38 and/or any additional modular panels added to the outdoor kitchen assembly 20 may be attached in any suitable method that does not require the use of tools or fasteners. In the embodiment shown, a tongue and groove system is used to join two or more of the modular panels together. This tongue and groove system does not require bolts, screws, or other fasteners to be assembled and does not require the use of additional tools, making assembly of the outdoor kitchen assembly 20 easy without the need for professional help. Other attachment systems that do not require the use of tools for assembly may be used in alternative embodiments. For example, other embodiments may use pins or snaps to hold together the modular panels.

An exemplary tongue and groove system for securing the various modular panels of the outdoor kitchen assembly 20 is shown in FIG. 6. In this system, a first panel 110 includes a T-shaped tongue 115 that includes a narrow tongue portion 116 and a wide tongue portion 118 positioned distally from the narrow tongue portion 116. A second panel 120 includes a corresponding, T-shaped groove 125 that has a narrow groove portion 126 and a wide groove portion 128. The narrow groove portion 126 is sized so that the narrow tongue portion 116 may fit within the narrow groove portion 126; however, the wide tongue portion 118 may not fit within the narrow groove portion 126. Likewise, the wide groove portion 128 is sized so that the wide tongue portion 118 may fit within the wide groove portion 128. The tongue 115 may be slidably received within the groove 125, and the interference between the wide tongue portion 118 and the narrow groove portion 126 prevents lateral removal of the first panel 110 from the second panel 120. It shall be appreciated that other corresponding shapes are contemplated and may be utilized. In addition, the T-shaped tongue 115 and T-shaped groove 125 may be integrally formed or at least partially formed by an additional piece secured to the respective modular panel.

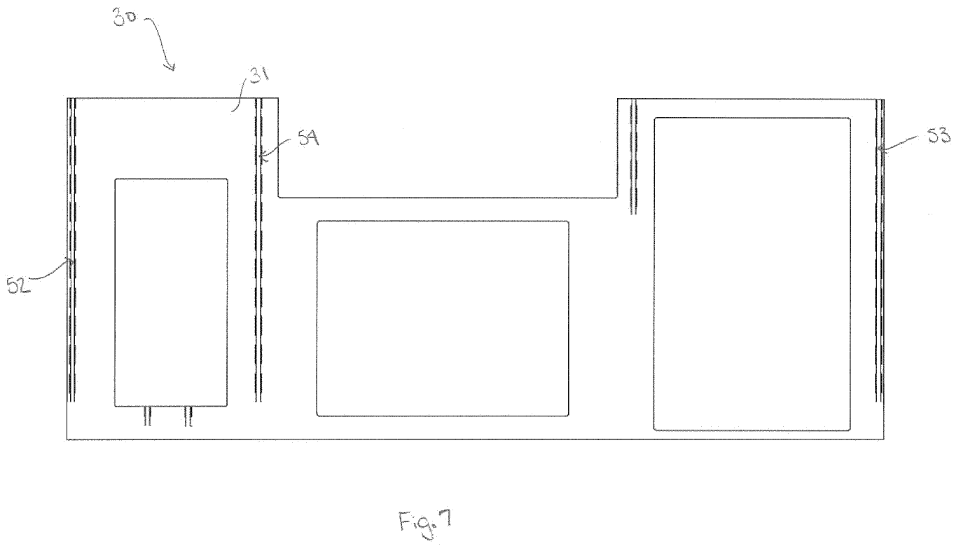

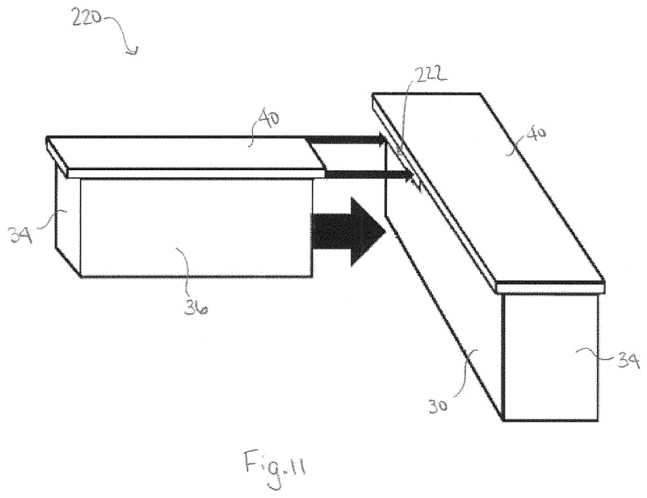

FIG. 7 illustrates the inside surface 31 of the front panel 30 that faces the interior space 25 of the outdoor kitchen assembly 20 when the outdoor kitchen assembly 20 is assembled. The front panel 30 includes a left side groove 52 defined near the left edge of the front panel 30. The left side groove 52 is dimensioned to receive a corresponding side panel tongue 62 (see FIG. 9) of the left side panel 34 to attach the side panel 34 to the front panel 30. Likewise, a right side groove 53 is defined near the right edge of the front panel 30 for receiving a corresponding tongue of the right side panel 32 to attach the side panel 32 to the front panel 30. An internal panel groove 54 is also defined in the front panel 30 and configured to receive a corresponding internal panel tongue 64 (see FIGS. 10A and 10B) to attach the internal panel 38 to the front panel 30.

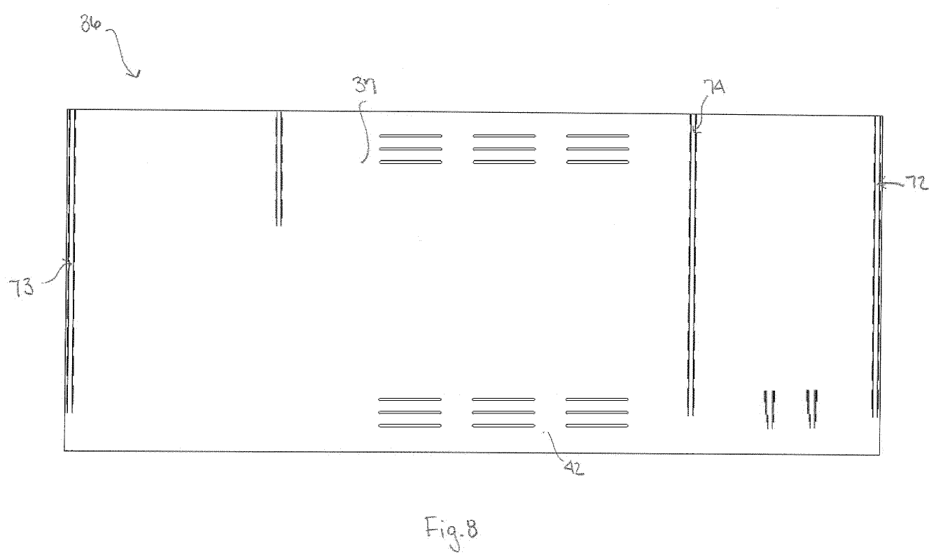

FIG. 8 illustrates the inside surface 37 of the back panel 36. The inside surface 37 of the back panel 36 includes a left side groove 72 that corresponds to the left side groove 52 of the front panel 30. Back panel 36 also includes a right side groove 73 that corresponds to the right side groove 53 of the front panel 30, and an internal panel groove 74 that corresponds to the internal panel groove 54 of the front panel 30. The left side groove 72 and the right side groove 73 are each dimensioned to receive a corresponding side panel tongue 62 and the internal panel groove 74 is dimensioned to receive a corresponding internal panel tongue 64.

When constructed, the left side panel 34 spans between the front panel 30 and the back panel 36. One of the side panel tongues 62 of the left side panel 34 (see FIG. 9) is slidably inserted into the left side groove 52 of the front panel 30 while the other side panel tongue 62 of left side panel 34 is slidably inserted into the left side groove 72 of the back panel 36. This is repeated with the right side panel 32, which spans between the front panel 30 and the back panel 36. A side panel tongue 62 of the right side panel 32 is slidably inserted into the right side groove 53 of the front panel 30 while the opposite side panel tongue 62 of the right side panel 32 is slidably inserted into the right side groove 73 of the back panel 36. The internal panel 38 is similarly situated, spanning the front panel 30 and the back panel 36 with one of the internal panel tongues 64 slidably inserted into the internal panel groove 54 of the front panel 30 and the opposite internal panel tongue 64 slidably inserted into the internal panel groove 74 of the rear panel 30.

Although the embodiment shown has the grooves on the front panel 30 and the back panel 36 and the tongues on the side panels 32, 34, in other embodiments, the arrangement of the tongues and grooves may be modified as desired. As an example, in another embodiment, the tongues may be included on the front panel 30 and the back panel 36 while the grooves are positioned on the side panels 32, 34. In another embodiment, each panel may include a combination of tongues and grooves. For example, the front panel 30 may have a tongue that corresponds with a groove in the right side panel 32 and the front panel 30 may have a groove that corresponds with a tongue on the left side panel 34.

FIG. 10A is a front view and FIG. 10B is a top view of the internal panel 38. Similar to the side panels 32, 34, the internal panel 38 may include a vent opening 43 near the top edge of the internal panel 38. The vent opening 43 of the internal panel 38 can operate with the vent openings 44, 46 of the side panels to ensure airflow within the interior space 25 of the outdoor kitchen assembly 20. An internal panel opening 39 is also defined through internal panel 38 to allow additional airflow within the interior space 25 of the outdoor kitchen assembly 20.

In the embodiment shown in FIG. 1, there is one cutout panel 38 included in the outdoor kitchen assembly 20. However, in other embodiments, additional internal panels may optionally be included where desired to provide additional rigidity to the structure of the outdoor kitchen assembly 20. In these embodiments, additional grooves on the inside surfaces of the front panel 30 and the back panel 36 may be added to allow attachment of the additional panel or additional panels. In other embodiments, there may be no internal panels 38.

The outdoor kitchen assembly 20 shown in FIG. 1 only shows a certain embodiment of the type of structure that can be built using the modular panels. Because of the ease of installation and the self-supporting nature of the modular panels, the panels may be arranged in many desired shapes or arrangements depending on the desires of the user of the outdoor kitchen assembly 20. In some embodiments, a greater number modular panels may be added to increase the size of the outdoor kitchen assembly 20 to allow additional appliances to be added to the outdoor kitchen assembly 20 or to allow for additional counter space. In other embodiments, one or more of the modular panels may have a different shape than square or rectangular, as desired, to fit a particular shape for the outdoor kitchen assembly. Additionally, the modular panels may be formed in varying sizes as desired to modify the length, width, and/or height of the outdoor kitchen assembly.

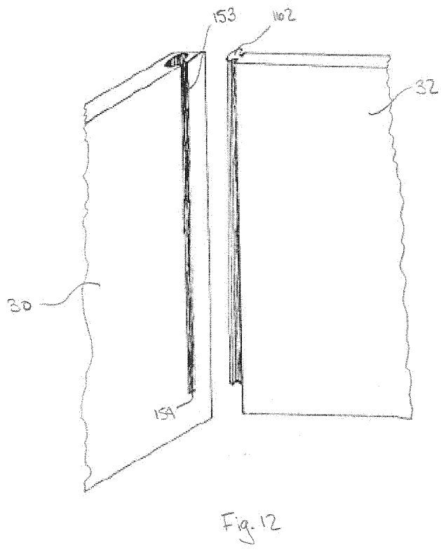

In one example, shown in FIG. 11, the outdoor kitchen assembly may be formed in an L-shape to form an L-shaped outdoor kitchen assembly 220. Typically, because the countertop 40 includes an overhang past the modular panels 30, 32, 34, 36 of the outdoor kitchen assembly 20, the countertop 40 may interfere with the modular panels of a first portion of the L-shape assembly 220 from laying flush to the modular panels of a second portion of the L-shape assembly 220. This issue may be solved by the first portion of the L-shape assembly 220 having a height that is smaller than the height of the second portion of the L-shape assembly 220. A slot 222 may be defined through one of the modular panels of the second portion of the L-shape and sized to receive the countertop 40 of the first portion of the L-shape assembly 120. The overhang portion of the countertop 40 may be inserted through this slot so that the side modular panel of the first portion may be arranged flush to corresponding side modular panel of the second portion.

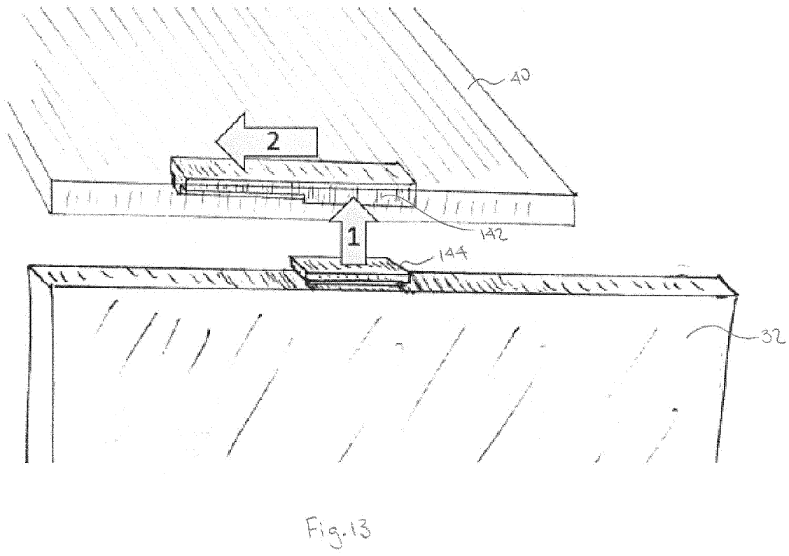

A further embodiment of the tongue and groove system is illustrated in FIG. 12. In this embodiment, a groove 153 is defined through a portion of the front panel 30. The groove 153 extends through the top edge of the front panel 30, but does not extend through the entire height of the front panel 30, stopping short of the bottom edge of the front panel 30. Likewise, a corresponding tongue 162 on the right side panel 32 extends to the top edge of the right panel 32, but does not extend the entire height of the right panel 32, stopping short of the bottom edge of the right panel 32. The bottom stop 154 of the groove 153 acts as a stop that prevents the tongue 162 from sliding any further within the groove 153. The groove 153 may be positioned so that the bottom stop 154 is positioned at a height that aligns at least the bottom edge of the front panel with the bottom edge of the right side panel 32 when the tongue 162 is slidably inserted into groove 153.

It should be realized that this further embodiment of the tongue and groove system could be used for each of the connections between panels of the outdoor kitchen assembly 20. For example, the left side panel 34 may attach to the front panel 30 using this tongue and groove system and the left side panel 34 may also be attached to the back panel using 36 using the same tongue and groove system. Additionally, the location of the tongue 162 and the groove 153 may be switched in other embodiments. For example, in other embodiments, the groove 153 may be located on the right side panel 32 and the tongue 162 may extend from the front panel 30.

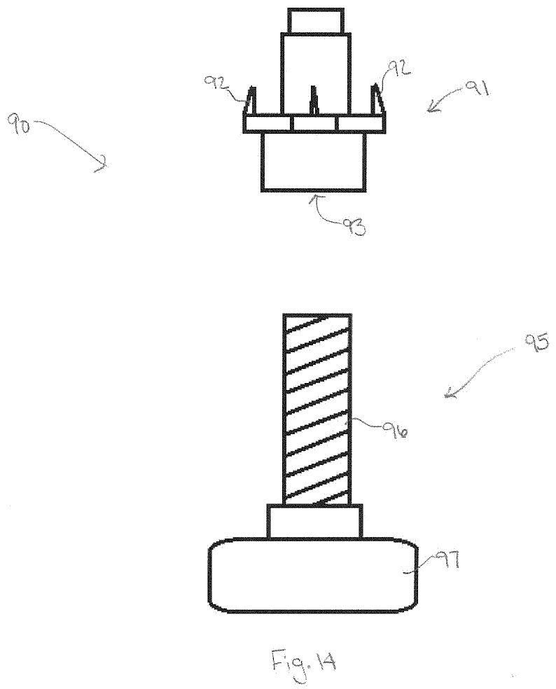

A further embodiment of the countertop 40 to the panels 30, 32, 34, 36 is shown in FIG. 13. In this embodiment, the countertop 40 includes at least one gap 142 that is defined through a portion of the countertop. In the illustrated embodiment, gap 142 is shown in a hidden view, as it is formed in the underside of countertop 40. Gap 142 may be located near an edge of the countertop that will positioned above or adjacent to the top edge of one of the panels 30, 32, 34, 36. Therefore, in the embodiment shown, the counter top includes four gaps 142, and each of the gaps corresponds to one of the front panel 30, side panels 32, 34, or the back panel 26. Each of the panels 30, 32, 34, 36 includes a tenon 144 that extends from the top edge of the panel 30, 32, 34, 36 and that is aligned with a corresponding gap 142 in the countertop 40. The tenon 144 of each panel is located so as to be inserted into the corresponding gap 142 in the countertop 40 when the outdoor kitchen assembly 20 is properly assembled. The countertop 40 is then slid laterally in a direction perpendicular to the height of the panel and typically along the length of the panel so that the tenons 144 slide within gaps 142 and lock therein. This locks the countertop 40 in place and provides additional support for attaching the adjacent panels 30, 32, 34, 36 to each other.

In some embodiments, the gaps 142 and tenons 144 may have a similar arrangement as the tongue and groove system. The tenon 144 has dimensions that allow insertion into the gap 142; however, once inserted into the gap 142, the tenon 144 may slide to a location where the dimension of the gap 142 is smaller, and the tenon 144 is prevented from being removed from the gap 142. These tenons 144 and the connection to the countertop 40 help to lock the side panels 32, 34 in place. The side panels 32, 34 cannot slide downward along the front panel 30 or the back panel 36 as they are prevented from moving downward either by the support surface or by the bottom stop 154 in the groove. The countertop 40 and the insertion of tenon 144 into gap 142 and sliding the tenon 144 into a locked position prevents the side panels 32, 34 from sliding upward with respect to the front panel 30 or the back panel 36. This forces the outdoor kitchen assembly 20 to remain square and prevents accidental separation of the side panels 32, 34 from the front panel 30 or the back panel 36.

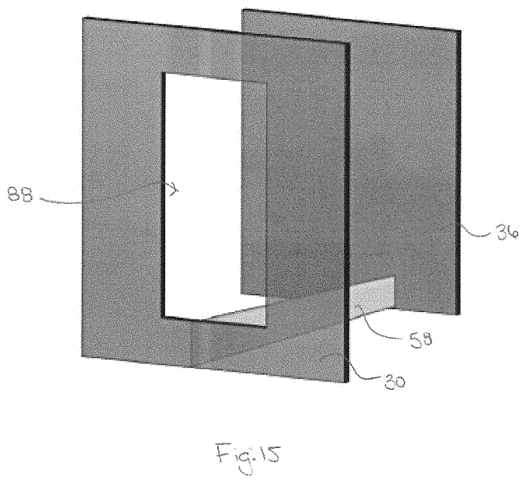

In some embodiments, adjustable feet may be included in the panels to easily allow height adjust to easily allow the outdoor kitchen assembly 20 to be leveled or set as desired. One or more adjustable feet may be attached to the bottom edge of the front panel 30 and/or to the bottom edge of the back panel 36 through pre-cut openings. An example of an adjustable foot assembly 90 that may be used is shown in FIG. 14. In this example, the adjustable foot assembly 90 includes a female connection 91 that is inserted into a recess formed in the bottom edge of either the front panel 30 or the bottom edge of the back panel 36. The female connector 91 may include one or more spikes 92 to further secure the female connector 91 to the front panel 30 or the back panel 36. The female connector 91 may also include a threaded recess 93 to receive a foot 95 that includes a threaded fastener 96 to be received in the threaded recess 93 to connect the foot 95 to the female connector 91. The foot 95 includes a foot base 97 that is designed to rest on a support surface such as the floor or the ground. The height of the foot 95 with respect to the female connector 91, and therefore the front panel 30 or back panel 36, may be adjusted by tightening or loosening the threaded fastener 96 within the female connector 91.

Any number of adjustable foot assemblies 90 may be used for the outdoor kitchen assembly 90 and can be used on all of the panels 30, 32, 34, 36 or only a portion of the panels if desired. As an example, in some embodiments, multiple adjustable foot assemblies 90 may be evenly spaced on the bottom edge of the front panel 30 and the back panel 36. The height of each foot may be adjusted individually to properly level the outdoor kitchen assembly 20.

As illustrated in FIG. 15, some embodiments of the outdoor kitchen assembly 20 may include one or more support braces 58 for supporting the appliances that are installed in the outdoor kitchen assembly 20. Typically, the appliances are attached to the front panel 30 by screws, bolts, or other suitable attachment methods. However, for heavy appliances, the attachment to front panel 30 places stress on the front panel 30. A support brace 58 may be placed within the interior space 25 of the outdoor kitchen assembly 20 and span between the front panel 30 and the rear panel 36 at the desired location for the appliance. However, in other embodiments, the support brace 58 may span between any desired panels. Typically, the support brace 58 is positioned so that it is raised above the support surface on which the outdoor kitchen assembly 20 rests. The installed appliance may then rest on support brace 58 or on multiple support braces 58 to provide additional support for the appliance and to relieve some of the stress placed on the front panel 30.

In some embodiments, the support brace 58 or support braces 58 may connect to the front panel 30 and the back panel 36 using the same type of tongue and groove system shown in FIG. 6. As an example, the support brace 58 may include a T-shaped tongue on each end of the support brace 58. Each T-shaped tongue fits into a corresponding groove on the front panel 30 or the back panel 36. The support brace 58 may then be slid downward into a narrower part of the grooves that do not allow the T-shaped tongues to be removed, connecting the support brace 58 to the front panel 30 and the back panel 36, respectively. The grooves may have a bottom stop, similar to the bottom stop 154 shown in FIG. 12, which prevents the support brace 58 from sliding all the way to the floor. In some embodiments, this bottom stop provides at least 0.5 inches of clearance between the floor and the support brace 58. It should also be noted, that in other embodiments, the groove may be located on the support brace 58 and the tongues may be located on the front panel 30 and the back panel 36.

In some embodiments, a support brace 58 or multiple support braces 58 may be arranged to span the front panel 30 and the back panel 36 near the top edge, so that the support brace 58 may provide extra support for the countertop 40. These support braces 58 may include an opening defined through the width of the support brace 58 to allow gases and heat to vent through the support brace.

The modular structure of the outdoor kitchen assembly 20 provides several advantages when compared to an outdoor kitchen surround that is completely built on-site. Installation of the modular outdoor kitchen assembly 20 can be completed in a much shorter amount of time and without the need for masonry. Minimal construction skills are needed to assembly the modular panels, so a typical homeowner is able to install their own outdoor kitchen assembly 20 without assistance from a professional, saving time and money.

Unlike stone or concrete kitchen assemblies, the modular panels and the countertop of the outdoor kitchen assembly 20 are lightweight and do not require a poured foundation to accommodate the weight of the structure. This provides more options as to which surfaces the outdoor kitchen assembly 20 may be situated, such as wooden decks, since there is less structural support necessary for the outdoor kitchen assembly 20. Additionally, the modular panels provides structural support for the countertop 40 and the whole assembly 20 so that a sub-structure frame or a block structure is not required. This decreases cost, assembly time, and reduces the dependence on specialized labor skills for installation.

In a further form, one or more metal plates or magnets may be secured to or set into one or more of the panels to provide support for easily detachable covers. For example, magnets and/or metal plates may be inserted into the front and rear panels surrounding the perimeter of the grill to enable a traditional grill cover, such as one made of canvas or some other durable water-resistant material, to be easily positioned over the grill and secured in place by connection to the outdoor kitchen assembly 20. In such event, the grill cover would be modified to include magnets or metal pieces for being securely retained by a magnet near its outer ends, which match up to and connect with magnets or metal plates positioned on the outdoor kitchen assembly 20. In a further form, rather than magnets or metal connectors, the grill cover may be retractably mounted to or within the rear or the outdoor kitchen assembly 20.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A modular assembly comprising:
a front panel including a front panel top edge;
a back panel including a back panel top edge;
a right side panel including a right side panel top edge, wherein said right side panel spans between the front panel and the back panel;
a left side panel including a left side panel top edge, wherein said left side panel spans between the front panel and the back panel;
a countertop including a gap defined through a portion of an underside of said countertop;
at least one tenon wherein said at least one tenon extends from one of said front panel top edge, said back panel top edge, said right side panel top edge, or said left side panel top edge;
wherein said gap is positioned to align with said at least one tenon when said countertop is positioned on the top edges of said front panel, said back panel, said right side panel, and said left side panel; and
wherein said at least one tenon is dimensioned to fit within said gap, and wherein lateral movement of said at least one tenon within said gap is configured to secure said countertop to the panels.

2. A modular assembly comprising:
a front panel;
a back panel;
a right side panel spanning between the front panel and the back panel;
a left side panel spanning between the front panel and the back panel;
an internal panel including an internal panel top edge and an internal panel bottom edge, wherein said internal panel spans between the front panel and the back panel;
a countertop positioned on top of said front panel, said back panel, said right side panel, and said left side panel;
wherein said front panel, said back panel, said right side panel, and said left side panel are connected together to define an interior space between the panels;
wherein the internal panel is positioned between said right side panel and said left side panel and within said interior space; and
wherein an internal panel opening and a plurality of internal panel vent openings are defined through said internal panel to allow airflow within said interior space.
